(19) United States
(12) Patent Application Publication
(10) Pub. No.: US 2008/0163230 A1
(43) Pub. Date: Jul. 3, 2008

(54) METHOD AND APPARATUS FOR SELECTION AMONG MULTIPLE EXECUTION THREADS

(76) Inventors: Fernando Latorre, Huesca (ES); Jose Gonzalez, Terrassa (ES); Antonio Gonzalez, Barcelona (ES)

Correspondence Address: INTEL CORPORATION;c/o INTELLEVATE, LLC, P.O. BOX 52050, MINNEAPOLIS, MN, 55402, US

(21) Appl. No.: 11/618,571

(22) Filed: Dec. 29, 2006

(51) Int. Cl. G06F 9/50

(52) U.S. Cl. 718/104

(57) ABSTRACT

Methods and apparatus for selecting and prioritizing execution threads for consideration of resource allocation include eliminating threads for consideration from all the running execution threads: if they have no available entries in their associated reorder buffers, or if they have exceeded their threshold for entry allocations in the issue window, or if they have exceeded their threshold for register allocations in some register file and if that register file also has an insufficient number of available registers to satisfy the requirements of the other running execution threads. Issue window thresholds may be dynamically computed by dividing the current number of entries by the number of threads under consideration. Register thresholds may also be dynamically computed and associated with a thread and a register file. Execution threads remaining under consideration can be prioritized according to how many combined entries the thread occupies in the resource allocation stage and the issue window.

### FIELD OF THE DISCLOSURE

This disclosure relates generally to the field of microprocessors. In particular, the disclosure relates to scheduling and/or allocation of execution resources to multiple execution threads in a multithreaded processor.

### BACKGROUND OF THE DISCLOSURE

Computing systems and microprocessors frequently support multiprocessing, for example, in the form of multiple processors, or multiple cores within a processor, or multiple software processes or threads (historically related to co-routines) running on a processor core, or in various combinations of the above.

In modern microprocessors, many techniques are used to increase performance. Pipelining is a technique for exploiting parallelism between different instructions that have similar stages of execution. These stages are typically referred to, for example, as instruction-fetch, decode, operand-read, execute, write-back, etc. By performing work for multiple pipeline stages in parallel for a sequence of instructions the effective machine cycle time may be reduced and parallelism between the stages of instructions in the sequence may be exploited.

The technique of executing multiple software processes or threads on a microprocessor is another technique for exploiting parallelism between different instructions. For example, when an instruction cache miss occurs for one particular execution thread, instructions from another execution thread may be fetched to fill the pipeline bubbles that would otherwise have resulted from waiting for the missing cache line to be retrieved from external memory.

Simultaneous multithreading permits multiple independent threads to issue instructions each cycle in a wide-issue superscalar processor for parallel execution. By dynamically allocating execution resources to multiple threads throughput and utilization of execution resources may be substantially increased.

On the other hand, conditions such as the exhaustion of some particular type of internal resource (e.g. registers, functional units, issue window entries, etc.) may cause one or more of the execution threads to stall. While one execution thread is stalled, any resources that have been allocated to that thread are not being effectively utilized and are not available to other execution threads. Thus progress of other threads in the pipeline may also be blocked, reducing the effectiveness of executing multiple threads in parallel.

Some simultaneous multithreading techniques have been proposed for selecting instructions from “good” threads to improve the utilization of internal resources and avoid allocation of resources to “bad” threads. For example, priority may be given to a thread with the least unresolved branches in order to avoid execution of a wrongly taken path. Alternatively, priority may be given to a thread with the least outstanding data cache misses to avoid allocating resources to threads that are stalled waiting for loads to complete. Another alternative might be to award priority to a thread with the least instructions in the decode stage, the register renaming stage and the instruction queues of the pipeline in order to favor threads that are moving instructions through the instruction queues most efficiently and provide an even mix of instructions from the available threads. One advantage to these techniques is that they are relatively easy to implement with simple counters in a processor.

One drawback to these simple techniques is that fairness of resource allocation among threads may be compromised and in some cases a thread may be starved for a lack of resources. What is desired is a technique that minimizes inter-thread starvation, improves fairness of resource allocation and at the same time increases the throughput of the simultaneous multithreaded processor.

### BRIEF DESCRIPTION OF THE DRAWINGS

The present invention is illustrated by way of example and not limitation in the figures of the accompanying drawings.

FIG. 1 illustrates one embodiment of a processor pipeline in which a selection process occurs among multiple execution threads for simultaneous multithreading.

FIG. 2 illustrates a flow diagram for one embodiment of a process to select among multiple execution threads for simultaneous multithreading.

FIG. 3 illustrates a flow diagram for an alternative embodiment of a process to select among multiple execution threads for simultaneous multithreading.

FIG. 4 illustrates a flow diagram for one embodiment of a process to dynamically compute threshold values for a particular thread and a particular register file for use in a register allocation filter.

FIG. 5 illustrates one embodiment of a computing system in which a selection process occurs among multiple execution threads for simultaneous multithreading.

### DETAILED DESCRIPTION

Disclosed herein are computer implemented processes and apparatus for selecting and prioritizing execution threads under consideration of resource allocation. Selecting may include eliminating threads for consideration from all the running execution threads: if they have no available entries in their associated reorder buffers, or if they have exceeded their threshold for entry allocations in the issue window. Issue window thresholds may be dynamically computed by dividing the current number of entries by the number of threads under consideration. Selecting may further include eliminating threads under consideration if they have exceeded their threshold for register allocations in some register file and that register file has an insufficient number of available registers to satisfy the requirements of the other running execution threads. Register thresholds may be dynamically computed values associated with a particular thread and a particular register file. Any running execution threads remaining under consideration may then be prioritized according to how many combined entries the thread occupies in the resource allocation stage and in the issue window.

By employing embodiments of the disclosed processes and apparatus, processor hardware may be adapted to the resource requirements of different threads for simultaneous multithreading (SMT) minimizing inter-thread starvation, improving fairness of resource allocation and increasing performance.

These and other embodiments of the present invention may be realized in accordance with the following teachings and it should be evident that various modifications and changes may be made in the following teachings without departing from the broader spirit and scope of the invention. The specification and drawings are, accordingly, to be regarded in an illustrative rather than restrictive sense and the invention measured only in terms of the claims and their equivalents.

Some embodiments may make use of Intel® Hyper-Threading Technology (see Intel Technology Journal, Volume 06, Issue 01, Feb. 14, 2002, ISSN 1535766X, available online at intel.com/technology/itj/2002/volume06issue01/ for download as the file vol6iss1_hyper_threading_technology.pdf). In the following discussion, some known structures, circuits, architecture-specific features and the like have not been shown in detail to avoid unnecessarily obscuring the present invention.

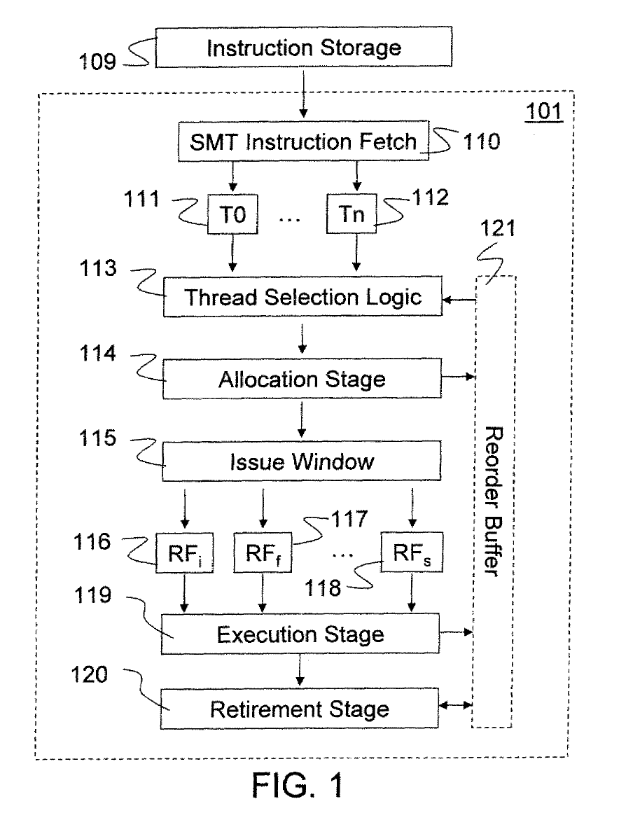

FIG. 1 illustrates one embodiment of a processor pipeline 101 in which a selection process occurs among multiple execution threads T0 through Tn for simultaneous multithreading (SMT). Instruction storage 109 holds instructions of threads T0 through Tn, which are fetched for execution by SMT instruction fetch logic 110 and queued into thread queues 111 through 112.

Thread selection logic 113 may perform a selection process adapted to the resource requirements of threads T0 through Tn to avoid inter-thread starvation, improve fairness of resource allocation and increase performance by dynamically computing resource thresholds for each of the competing threads and filtering out those threads that have exceeded their resource thresholds. Thread selection logic 113 may also prioritize any remaining threads in order to select new instructions to be forwarded to allocation stage 114.

In allocation stage 114 certain resources may be allocated to the instructions. In some embodiments, for example, registers may be renamed and allocated from the physical registers of register files 116, 117 or 118 in accordance with register alias table entries for each thread.

In issue window 115 instructions of threads T0 through Tn occupy entries and await issuance to their respective register files and execution units. In some embodiments, for example, integer instructions may be issued to receive operands from RFi 116 for execution in an integer arithmetic/logical unit (ALU); floating point instructions may be issued to receive operands from RFf 117 for execution in a floating point adder or floating point multiplier, etc.; and single instruction multiple data (SIMD) instructions may be issued to receive operands from RFs 118 for execution in a SIMD ALU, SIMD shifter, etc.

After instructions are issued, they receive their operand registers from their respective register files 116, 117, or 118 as they become available and then proceed to execution stage 119 where the are executed either in order or out of order to produce their respective results. In embodiments that optionally execute instructions out of sequential order, retirement stage 120 may employ a reorder buffer 121 to retire the instructions of threads T0 through Tn in their respective original sequential orders.

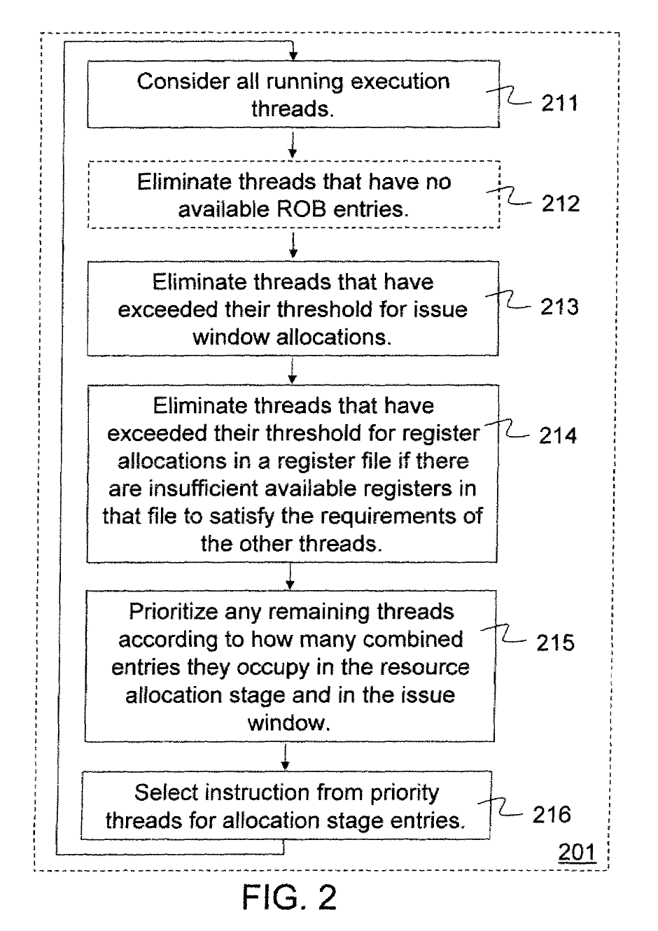

FIG. 2 illustrates a flow diagram for one embodiment of a process 201 to select among multiple execution threads for simultaneous multithreading. Process 201 and other processes herein disclosed are performed by processing blocks that may comprise dedicated hardware or software or firmware operation codes executable by general purpose machines or by special purpose machines or by a combination of both.

In processing block 211 all running execution threads are selected for consideration. In processing block 212 threads, which may optionally be executed out of sequential order are eliminated from consideration among the running execution threads if they have no available entries in their associated reorder buffers (ROBs). In processing block 213 threads are eliminated from consideration among the running execution threads if they have exceeded their respective threshold values for entry allocations in the issue window. For one embodiment, these threshold values may be dynamically computed as the current number of entries in the issue window divided by the number of running execution threads that remain under consideration. In processing block 214 threads are eliminated from consideration among the running execution threads if they have exceeded their threshold values for register allocations in a register file and that register file has an insufficient number of available registers to satisfy the register requirements of any one of the other running execution threads.

In processing block 215 any execution threads that remain under consideration may be prioritized according to how many combined entries each thread occupies in the resource allocation stage and in the issue window. Those threads that occupy fewer combined entries in the allocation stage and in the issue window may be given priority over threads that occupy more combined entries. Instructions are selected in processing block 216 to receive entries in the allocation stage from those threads that were awarded priority in processing block 215.

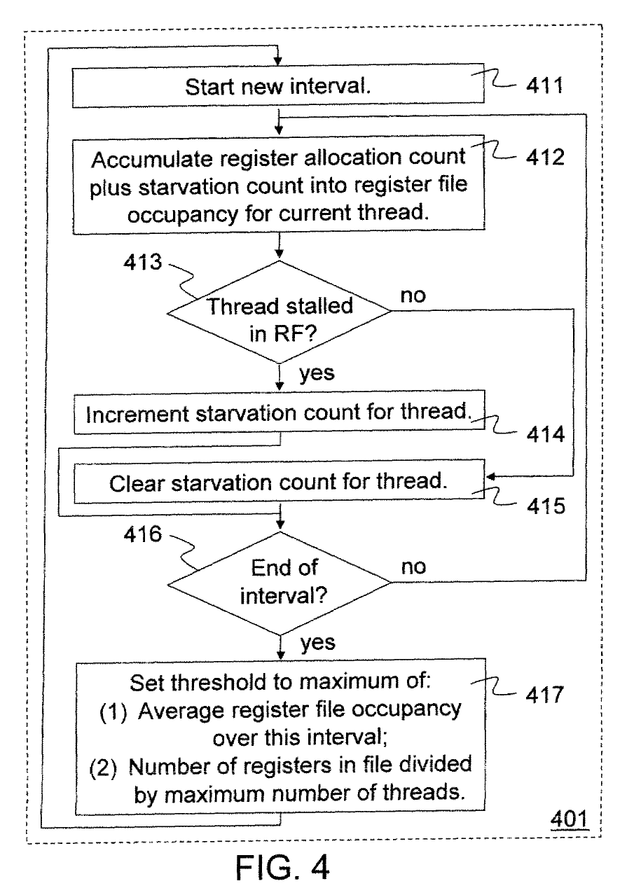

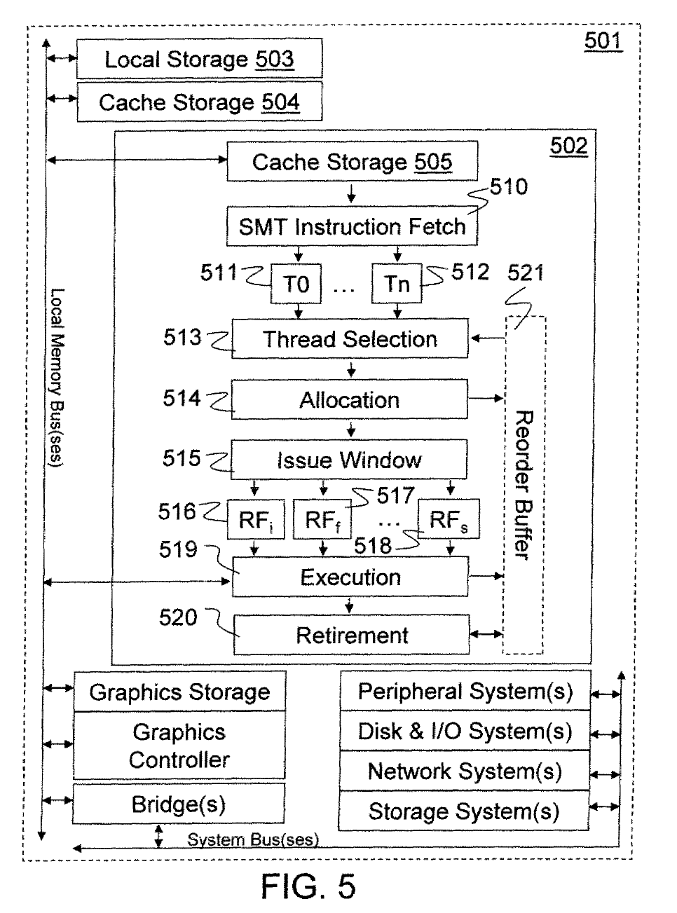

As explained below in greater detail, especially with regard to FIGS. 4 and 5, by employing embodiments of process 201, processor hardware may adapt to the resource requirements of the running execution threads to reduce inter-thread starvation, improve fairness of resource allocation and increasing SMT performance.

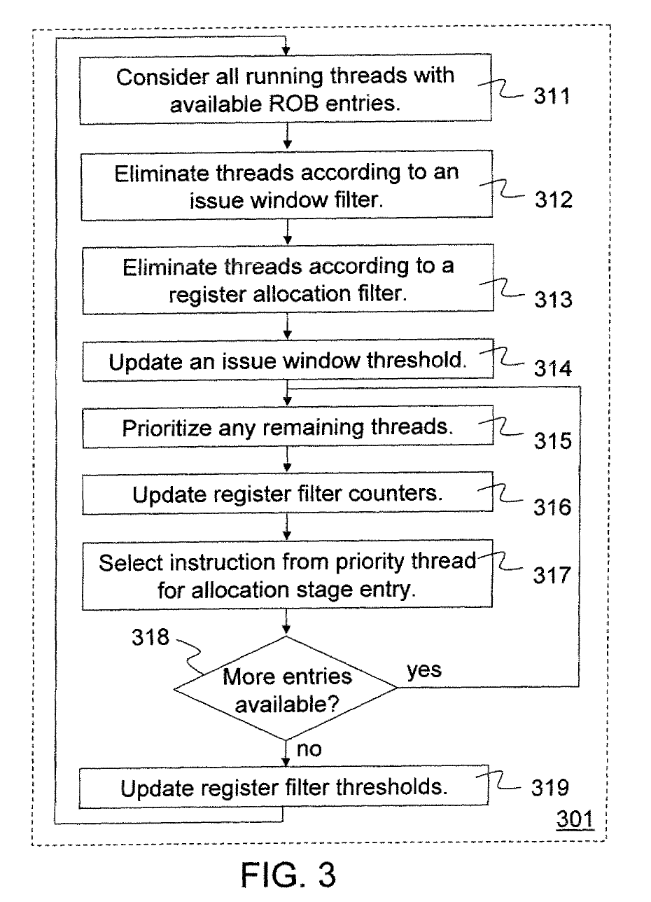

FIG. 3 illustrates a flow diagram for an alternative embodiment of a process 301 to select among multiple execution threads for SMT. In processing block 311 all running execution threads with available ROB entries are selected for consideration. In processing block 312 threads are eliminated from consideration among the running execution threads according to an issue window filter, for example, because they have exceeded their respective threshold values for entry allocations in the issue window as in processing block 213. In processing block 313 threads are eliminated from consideration among the running execution threads according to a register allocation filter, for example, because they have exceeded their threshold value for register allocations in a register file with an insufficient number of available registers as in processing block 214. In processing block 314 an issue window threshold may be updated for use by the issue window filter. It will be appreciated that in some embodiments updating of an issue window threshold may occur in a different order with respect to other processing blocks illustrated in process 301 or concurrently with other processing blocks illustrated in process 301.

In processing block 315 any execution threads that remain under consideration may be prioritized. In processing block 316 register filter counters, for example, to track register allocation and/or starvation may be updated. It will be appreciated that in some embodiments updating of register filter counters may also occur in a different order with respect to other processing blocks illustrated in process 301 or concurrently with other processing blocks illustrated in process 301.

In processing block 317 an instruction is selected from the thread that was awarded priority in processing block 315 to receive an entry in the allocation stage. Then in processing block 318 it is determined whether any more allocation stage entries are available, and if so, processing repeats at processing block 315. Otherwise processing continues in processing block 319, where the register filter thresholds are updated. As with processing blocks 314 and 316, updating register filter thresholds may occur in a different order with respect to other processing blocks illustrated in process 301 or concurrently with other processing blocks illustrated in process 301. Processing then reiterates the process 301 beginning in processing block 311.

The number of required registers may vary greatly among threads. Therefore, it will be appreciated that the register filter thresholds may be dynamically computed threshold values associated with each thread and each register file. As it is explained in below, with regard to FIG. 4, register filter thresholds may be dynamically adapted to the resource requirements of their respective running execution threads to reduce inter-thread starvation and to improve fairness of resource allocation while increasing SMT performance.

FIG. 4 illustrates a flow diagram for one embodiment of a process 401 to dynamically compute threshold values for a particular thread and a particular register file for use in a register allocation filter. In processing block 411 a new time interval begins. In processing block 412 a register allocation count representing the number of registers allocated plus a starvation counter for the current thread in the current register file are accumulated into a register file occupancy value for the current thread. In processing block 413 it is determined whether the current thread is stalled due to a lack of registers in the current register file. If so, a starvation count is incremented for the current thread in processing block 414. Otherwise, the starvation count is cleared to zero in processing block 415. Processing then proceeds to processing block 416 where it is determined whether the current time interval is ended. If not, processing reiterates beginning at processing block 412, but if the current time interval is ended, then processing continues in processing block 417 where the register filter threshold for the current thread in the current register file is set to the maximum value of: (1) the average register file occupancy for the current tread in the current register file over the duration of this time interval, and/for (2) the number of registers in the current register file divided by the maximum number of running execution threads. Next processing begins another time interval in processing block 411.

It will be appreciated that the average register file occupancy value over a time interval indicates the register requirements of a particular thread in that register file. If a thread is starved for registers the starvation counter increases the average register file occupancy value to permit more registers to be allocated to that thread in the next time interval. Thus the register filter thresholds may dynamically adapt to the register requirements of a thread in each register file as those requirements change over time.

FIG. 5 illustrates one embodiment of a computing system 501 in which a selection process occurs among multiple execution threads T0 through Tn for SMT. Computing system 501 may include a processor 502, an addressable memory, local storage 503, and cache storage 504 to store data and executable programs, graphics storage and a graphics controller, and various systems optionally including peripheral systems, disk and I/O systems, network systems including network interfaces to stream data for storage in addressable memory, and external storage systems including magnetic storage devices to store instructions of multiple software execution threads, wherein the instructions being accessed by the processor 502, cause the processor to process the instructions of the multiple software execution threads.

Cache storage 505 retrieves and holds copies of instructions for threads T0 through Tn, which are fetched for execution by SMT instruction fetch logic 510 and queued into thread queues 511 through 512.

Thread selection logic 513 may perform a selection process adapted to the resource requirements of threads T0 through Tn to avoid inter-thread starvation and improve fairness of resource allocation while increasing SMT performance by dynamically computing resource thresholds for each of the competing threads and filtering out those threads that have exceeded their resource thresholds. Thread selection logic 513 may also prioritize any remaining threads in order to select new instructions to be forwarded to allocation stage 514.

In allocation stage 514 certain resources may be allocated to the instructions. In some embodiments, for example, registers may be renamed and allocated from the physical registers of register files 516, 517 or 518 in accordance with register alias table entries for each thread.

In issue window 515 instructions of threads T0 through Tn occupy entries and await issuance to their respective register files and execution units. By restricting the threads under consideration to threads that have not exceeded their respective thresholds for entry allocations in the issue window, thread selection logic 513 may improve fairness of resource allocation and increase SMT performance.

After instructions are issued, they receive their operand registers from their respective register files 516, 517, or 518 as they become available for execution stage 519 or in their respective register files. Then they proceed to execution stage 519 where the are executed either in order or out of order to produce their results. By restricting the threads under consideration to threads that have not exceeded their thresholds for register allocations in a register file with an insufficient number of available registers, thread selection logic 513 may avoid inter-thread starvation and the register thresholds may dynamically adapt to the register requirements of a thread in each register file as those requirements change over time.

In embodiments that optionally execute instructions out of sequential order retirement stage 520 may employ a reorder buffer 521 to facilitate retirement of the instructions of threads T0 through Tn in their respective original sequential orders. By restricting the threads under consideration to running threads with available ROB entries, thread selection logic 513 may avoid wasting allocation stage entries and issue window entries on threads that may remain blocked for a significant period of time.

Thus by employing the processes of selection logic 513 in processor 502, hardware resources may adapt to the requirements of the running execution threads to reduce inter-thread starvation, improve fairness of resource allocation and increasing SMT performance.

The above description is intended to illustrate preferred embodiments of the present invention. From the discussion above it should also be apparent that especially in such an area of technology, where growth is fast and further advancements are not easily foreseen, the invention may be modified in arrangement and detail by those skilled in the art without departing from the principles of the present invention within the scope of the accompanying claims and their equivalents.

What is claimed is:

1. A computer implemented method for selecting and prioritizing execution threads for consideration of resource allocation, the method comprising:
eliminating a first thread from consideration among a plurality of running execution threads:
(a) if it has no available entries in its associated reorder buffer,
(b) if it has exceeded a first threshold value for entry allocations in an issue window, or
(c) if it has exceeded a second threshold value for register allocations in a register file and if that register file has an insufficient number of available registers to satisfy the register requirements of a second thread of the plurality of running execution threads; and
prioritizing any threads of the plurality of running execution threads that remain under consideration according to how many combined entries each thread occupies in a resource allocation stage and in the issue window.

2. The method of claim 1 wherein the first threshold value is dynamically computed as the current number of entries in the issue window divided by the number of threads of the plurality of running execution threads that remain under consideration.

3. The method of claim 1 wherein the second threshold value is a dynamically computed threshold value associated with the first thread for that register file.

4. The method of claim 3 wherein dynamically computing the second threshold value comprises:
computing a register file occupancy for the first tread in that register file over a specified time interval;
setting the second threshold value to the maximum value of:
(1) the average register file occupancy for the first tread in that register file during that specified time interval, and
(2) the number of registers in that register file divided by the maximum number of running execution threads.

5. The method of claim 4 wherein computing the register file occupancy for the first thread in that register file over the specified time interval comprises:
accumulating, over the specified time interval, the number of registers allocated in that register file to the first thread plus a starvation counter for the first thread in that register file; and
incrementing the starvation counter for the first thread in that register file if the first thread is stalled because of a lack of available registers in that register file.

6. An apparatus comprising:
a plurality of thread instruction queues to store instructions of a plurality of running execution threads;
an instruction fetch unit to fetch instructions of the plurality of running execution threads and to store the fetched instructions in their respective thread instruction queues;
a register file having a plurality of physical registers;
an allocation stage having a plurality of allocation stage entries to store an instruction of the plurality of execution threads for renaming of a register operand of the instruction to a physical register of the register file;
an issue window having a plurality of issue window entries to store instructions of the plurality of execution threads for issue to the register file; and
thread selection logic to eliminate a first thread from consideration among the plurality of running execution threads:
(a) if it has exceeded a first threshold value for issue window entry allocations, or
(b) if it has exceeded a second threshold value for physical register allocations in the register file and if the register file has an insufficient number of available physical registers to satisfy the register requirements of a second thread of the plurality of running execution threads;
said thread selection logic further to prioritize a third thread of the plurality of running execution threads that remain under consideration for having the least combined allocation stage entries and issue window entries, and to select the instruction for storage in the allocation stage from said third thread.

7. The apparatus of claim 6 wherein the thread selection logic is further to eliminate the first thread from consideration among the plurality of running execution threads:
(c) if it has no available entries in a reorder buffer.

8. The apparatus of claim 6 wherein the first threshold value is dynamically computed as a total number of issue window entries divided by a number of threads of the plurality of running execution threads that have a free reorder buffer entry.

9. The apparatus of claim 6 wherein the first threshold value is dynamically computed as a number of issue window entries that are not currently allocated to a stalled thread, divided by a number of threads of the plurality of running execution threads that are not currently eliminated from consideration for having no free reorder buffer entries.

10. The apparatus of claim 6 wherein the first threshold value is dynamically computed as a number of issue window entries that are not currently allocated to a stalled thread, divided by a number of threads of the plurality of running execution threads that not currently eliminated from consideration for having no free reorder buffer entries or for having exceeded the second threshold value.

11. The apparatus of claim 6 wherein the second threshold value is associated with the first thread and the register file and is dynamically computed by:
computing a register file occupancy for the first thread in the register file over a current time interval;
setting the second threshold value to the maximum value of:
(1) the average register file occupancy for the first thread in the register file during the current time interval, and
(2) the number of physical registers in the register file divided by a maximum number of running execution threads.

12. The apparatus of claim 11 wherein computing the register file occupancy for the first thread in the register file over the current time interval comprises:
accumulating, over the current time interval, the number of physical registers allocated in the register file to the first thread plus a starvation counter for the first thread in the register file; and
incrementing the starvation counter for the first thread in the register file if the first thread is stalled because of a lack of available physical registers in the register file.

13. A computing system comprising:
an addressable memory to store instructions of a plurality of running execution threads,
a magnetic storage device;
a network interface; and
a processor to fetch instructions of the plurality of running execution threads from the addressable memory, the processor including:
a register file having a plurality of physical registers;
an allocation stage having a plurality of allocation stage entries to store an instruction of the plurality of execution threads for renaming of a register operand of the instruction to a physical register of the register file;
an issue window having a plurality of issue window entries to store instructions of the plurality of execution threads for issue to the register file; and
thread selection logic to eliminate a first thread from consideration among the plurality of running execution threads:
(a) if it has exceeded a first threshold value for issue window entry allocations, or
(b) if it has exceeded a second threshold value for physical register allocations in the register file and if the register file has an insufficient number of available physical registers to satisfy the register requirements of a second thread of the plurality of running execution threads;
said thread selection logic further to prioritize a third thread of the plurality of running execution threads that remain under consideration for having the least combined allocation stage entries and issue window entries, and to select the instruction for storage in the allocation stage from said third thread.

14. The system of claim 13 wherein the thread selection logic is further to eliminate the first thread from consideration among the plurality of running execution threads:
(c) if it has no available entries in a reorder buffer.

15. The system of claim 13 wherein the first threshold value is dynamically computed as a number of issue window entries that are not currently allocated to a stalled thread, divided by a number of threads of the plurality of running execution threads that are not currently eliminated from consideration for having no free reorder buffer entries.

16. The system of claim 13 wherein the first threshold value is dynamically computed as a number of issue window entries that are not currently allocated to a stalled thread, divided by a number of threads of the plurality of running execution threads that not currently eliminated from consideration for having no free reorder buffer entries or for having exceeded the second threshold value.

17. The system of claim 13 wherein the first threshold value is dynamically computed as a total number of issue window entries divided by a number of threads of the plurality of running execution threads that have a free reorder buffer entry.

18. The system of claim 17 wherein the second threshold value is associated with the first thread and the register file and is dynamically computed by:
computing a register file occupancy for the first thread in the register file over a current time interval;
setting the second threshold value to the maximum value of:
(1) the average register file occupancy for the first thread in the register file during the current time interval, and
(2) the number of physical registers in the register file divided by a maximum number of running execution threads.

19. The system of claim 18 wherein computing the register file occupancy for the first thread in the register file over the current time interval comprises:
accumulating, over the current time interval, the number of physical registers allocated in the register file to the first thread plus a starvation counter for the first thread in the register file; and
incrementing the starvation counter for the first thread in the register file if the first thread is stalled because of a lack of available physical registers in the register file.
